(19) United States
(12) Patent Application Publication
(10) Pub. No.: US 2014/0177559 A1
(43) Pub. Date: Jun. 26, 2014

(54) DATA COMMUNICATION METHOD IN NON-BEACON WIRELESS NETWORK AND NON-BEACON WIRELESS NETWORK COMMUNICATION SYSTEM

(71) Applicant: Samsung Electro-Mechanics Co., Ltd., Suwon-si (KR)

(72) Inventors: Sung Ho HWANG, Suwon-si (KR); Ji Hoon KIM, Suwon-si (KR); Bo Yle SEO, Suwon-si (KR); Chung Hee LEE, Suwon-si (KR)

(73) Assignee: Samsung Electro-Mechanics Co., Ltd., Suwon-si (KR)

(21) Appl. No.: 14/137,103

(22) Filed: Dec. 20, 2013

(30) Foreign Application Priority Data
Dec. 21, 2012 (KR) 10-2012-0150940

(51) Int. Cl. H04W 74/00

(52) U.S. Cl. CPC H04W 74/002
USPC 370/329

(57) ABSTRACT

The present invention relates to a data communication method in a non-beacon wireless network and a non-beacon wireless network communication system. In accordance with an embodiment of the present invention, a data communication method in a non-beacon wireless network including: checking whether a coordinator uses a channel or not by a first end node; transmitting a first control information message including its ID and data size to the coordinator after checking whether the channel is busy or not by the first end node; broadcasting broadcast_ACK information including the ID and the data size by the coordinator receiving the first control information message; and transmitting first transmit_data to the coordinator by the first end node receiving the broadcast_ACK information, wherein the data size is the size of the first transmit_data is provided. Further, a non-beacon wireless network communication system is provided.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2012-0150940, entitled filed Dec. 21, 2012, which is hereby incorporated by reference in its entirety into this application.”

### BACKGROUND OF THE INVENTION

1. Field of the Invention

The present invention relates to a data communication method in a non-beacon wireless network and a non-beacon wireless network communication system, and more particularly, to a data communication method in a non-beacon wireless network and a non-beacon wireless network communication system that can efficiently use a channel and reduce a delay time by allowing a coordinator to broadcast information including the size of transmitted and received data, which use the channel, to terminals in a wake-up state.

2. Description of the Related Art

A wireless sensor network, for example, a Zigbee technology is highlighted as a representative wireless communication technology in low speed, low price, and low power consumption applications. A non-beacon wireless sensor network structure consists of a PAN coordinator node, which manages the whole network, and end nodes. The end node repeats sleep/wake-up to reduce energy consumption and transmits and receives data in an idle state after checking data transmission and reception of other nodes through clear channel assessment (CCA) when there are data. If the end node in a sleep state wakes up, the end node requests a beacon request (Data Frame) message from the PAN coordinator and can know whether there are data to be transmitted to it. If there are data which are to be transmitted from the coordinator node, the end node receives data by requesting data reception and also receives network state information.

A data communication method in a conventional non-beacon wireless network is schematically shown in FIGS. 4A and 4B. As in FIG. 4A, when a first end node is a data transmission end node, the first end node transmits data to a PAN coordinator when there are data to be transmitted. At this time, the end node performs a frequency sensing operation (CCA) which is a CSMA/CA operation after waiting as long as a random value selected after generation of data and transmits data when the result of the CCA is determined as that the frequency is vacant. At this time, a second end node, which wants to receive data, periodically wakes up and requests data transmission (Data Request) from the PAN coordinator through the CCA after random time delay. At this time, the process of performing the data transmission request (Data Request) through the CCA after the random time delay by the second end node is the same as a data transmission request (Data Request) process of the first end node in FIG. 4B.

At this time, in the non-beacon method, the end terminal, which receives data through periodic wake-up, can't know priority or importance of data transmitted to it. Further, a delay time may occur due to repeated sequence of random time waiting and CCA after wake-up.

### RELATED ART DOCUMENT

### Patent Document

Patent Document 1: European Patent Laid-open Publication No. EP2107849A1 (laid-open on Oct. 7, 2008)

### SUMMARY OF THE INVENTION

Accordingly, the present invention has been invented in order to overcome the above-described problem that another second end node should repeatedly wait as in the prior art when the first end node is connected to the coordinator and the channel is busy.

In order to overcome the above-described problem, it is an object of the present invention to provide a technique that can receive only by a PAN coordinator and a simple information message to reduce a receive delay time of an end node.

Specifically, it is an object of the present invention to provide a technique that can efficiently use a channel and reduce a delay time by broadcasting information including the size of transmitted and received data, which use the channel, to terminals in a wake-up state through the coordinator.

In accordance with a first embodiment of the present invention to achieve the object, there is provided a data communication method in a non-beacon wireless network, including the steps of: checking whether a coordinator uses a channel or not by a first end node; transmitting a first control information message including its ID and data size to the coordinator after checking whether the channel is busy or not by the first end node; broadcasting broadcast_ACK information including the ID and the data size by the coordinator receiving the first control information message; and transmitting first transmit_data to the coordinator by the first end node receiving the broadcast_ACK information, wherein the data size is the size of the first transmit_data.

At this time, in an example, in the step of checking whether the channel is busy or not, the first end node may determine whether the channel is busy or not by detecting a power level, a carrier or a power level and a carrier through clear channel assessment (CCA) after waiting for a random time.

Further, in accordance with an example, the broadcast_ACK information may further include rapid access interval information.

At this time, in an example, the data communication method in a non-beacon wireless network may further include the step of transmitting a second control information message including its ID and data size to the coordinator within a rapid access interval after waiting as long as the size of the first transmit_data included in the broadcast_ACK information when a wake-up second end node receives the broadcast_ACK information. At this time, the data size included in the second control information message is 0 (zero).

Further, at this time, in the step of transmitting the second control information message, the second end node may transmit the second control information message after checking whether the channel is busy or not within the rapid access interval.

Further, in an example, the data communication method in a non-beacon wireless network may further include the step of starting transmission of second transmit_data to the coordinator within the rapid access interval after waiting as long as the size of the first transmit_data included in the broadcast_ACK information when the wake-up second end node, which wants to transmit data, receives the broadcast_ACK information.

At this time, in the step of transmitting the second transmit_data, the second end node may start the transmission of the second transmit_data after checking whether the channel is busy or not within the rapid access interval.

Next, in accordance with a second embodiment of the present invention to achieve the object, there is provided a data communication method in a non-beacon wireless network, including the steps of: checking whether a coordinator uses a channel or not by a first end node; transmitting a first control information message including its ID and data size to the coordinator after checking whether the channel is busy or not by the first end node; broadcasting broadcast_ACK information including the ID and the size of first receive_data, which are requested by the first end node, by the coordinator receiving the first control information message; and receiving the first receive_data, which are transmitted by the coordinator, after broadcasting by the first end node, wherein the data size included in the first control information message is 0 (zero).

At this time, in an example, in the step of checking whether the channel is busy or not, the first end node may determine whether the channel is busy or not by detecting a power level, a carrier or a power level and a carrier through clear channel assessment (CCA) after waiting for a random time.

Further, in accordance with an example, the broadcast_ACK information may further include rapid access interval information.

At this time, in an example, the data communication method in a non-beacon wireless network may further include the step of transmitting a second control information message including its ID and data size to the coordinator within a rapid access interval after waiting as long as the size of the first receive_data included in the broadcast_ACK information when a wake-up second end node receives the broadcast_ACK information. At this time, the data size included in the second control information message is 0 (zero).

Further, at this time, in the step of transmitting the second control information message, the second end node may transmit the second control information message after checking whether the channel is busy or not within the rapid access interval.

Further, in an example, the data communication method in a non-beacon wireless network may further include the step of starting transmission of transmit_data to the coordinator within the rapid access interval after waiting as long as the size of the first receive_data included in the broadcast_ACK information when the wake-up second end node, which wants to transmit data, receives the broadcast_ACK information.

At this time, in the step of transmitting the transmit_data, the second end node may start the transmission of the transmit_data after checking whether the channel is busy or not within the rapid access interval.

Next, in accordance with a third embodiment of the present invention to achieve the object, there is provided a non-beacon wireless network communication system including: a first end node for checking whether a coordinator uses a channel or not, transmitting a first control information message including its ID and a first data size to the coordinator after checking whether the channel is busy or not, receiving broadcast_ACK information of the coordinator for the first control information message, and transmitting first transmit_data to the coordinator or receive first receive_data from the coordinator after receiving the broadcast_ACK information; and the coordinator for receiving the first control information message from the first end node, broadcasting the broadcast_ACK information including the ID and a second data size, and receiving the first transmit_data from the first end node or transmitting the first receive_data to the first end node, wherein when the first end node transmits the first transmit_data, the first data size and the second data size are the size of the first transmit_data, and when the first end node requests the first receive_data, the first data size is 0 (zero), and the second data size is the size of the first receive_data.

At this time, in an example, the first end node may determine whether the channel is busy or not by detecting a power level, a carrier or a power level and a carrier through CCA after waiting for a random time.

Further, in an example, the broadcast_ACK information may further include rapid access interval information.

At this time, in an example, the non-beacon wireless network communication system may further include a second end node for receiving the broadcast_ACK information in a wake-up state, transmitting a second control information message including its ID and a third data size to the coordinator within a rapid access interval after waiting as long as the second data size included in the broadcast_ACK information when requesting second receive_data from the coordinator, and starting transmission of second transmit_data to the coordinator within the rapid access interval after waiting as long as the second data size included in the broadcast ACK_information when transmitting the second transmit_data to the coordinator. At this time, the third data size included in the second control information message is 0 (zero).

Further, at this time, the second end node may transmit the second control information message after checking whether the coordinator uses the channel or not within the rapid access interval when requesting the second receive_data, and start the transmission of the second transmit_data after checking whether the channel is busy or not within the rapid access interval when transmitting the second transmit_data.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A to 1E are views schematically showing a data communication method in a non-beacon wireless network and a non-beacon wireless network communication system in accordance with an embodiment of the present invention;

FIGS. 2A to 2E are views schematically showing a data communication method in a non-beacon wireless network and a non-beacon wireless network communication system in accordance with another embodiment of the present invention;

FIGS. 3A and 3B are views schematically showing a flow of signals in the data communication method in a non-beacon wireless network and the non-beacon wireless network communication system in accordance with an embodiment of the present invention; and

FIGS. 4A and 4B are views schematically showing a conventional data communication method in a non-beacon wireless network.

### DETAILED DESCRIPTION OF THE PREFERABLE EMBODIMENTS

Embodiments of the present invention to achieve the above-described objects will be described with reference to the accompanying drawings. In this description, the same elements are represented by the same reference numerals, and additional description which is repeated or limits interpretation of the meaning of the invention may be omitted.

In this specification, when an element is referred to as being “connected or coupled to” or “disposed in” another element, it can be “directly” connected or coupled to or “directly” disposed in the other element or connected or coupled to or disposed in the other element with another element interposed therebetween, unless it is referred to as being “directly coupled or connected to” or “directly disposed in” the other element.

Although the singular form is used in this specification, it should be noted that the singular form can be used as the concept representing the plural form unless being contradictory to the concept of the invention or clearly interpreted otherwise. It should be understood that the terms such as “having”, “including”, and “comprising” used herein do not preclude existence or addition of one or more other elements or combination thereof.

A typical non-beacon wireless sensor network, for example, a Zigbee network consists of a PAN coordinator node and at least one end node and is a method in which the PAN coordinator node controls PAN without sending a beacon signal to the end nodes belonging to the PAN. Since PAN synchronization by beacon isn't performed, the coordinator is always in active state and supports the end node to transmit data at any time. When there are data to be transmitted to the end node, if the end node is in a sleep state, the data is stored in a buffer and transmitted to the end node when there is a data request of the end node.

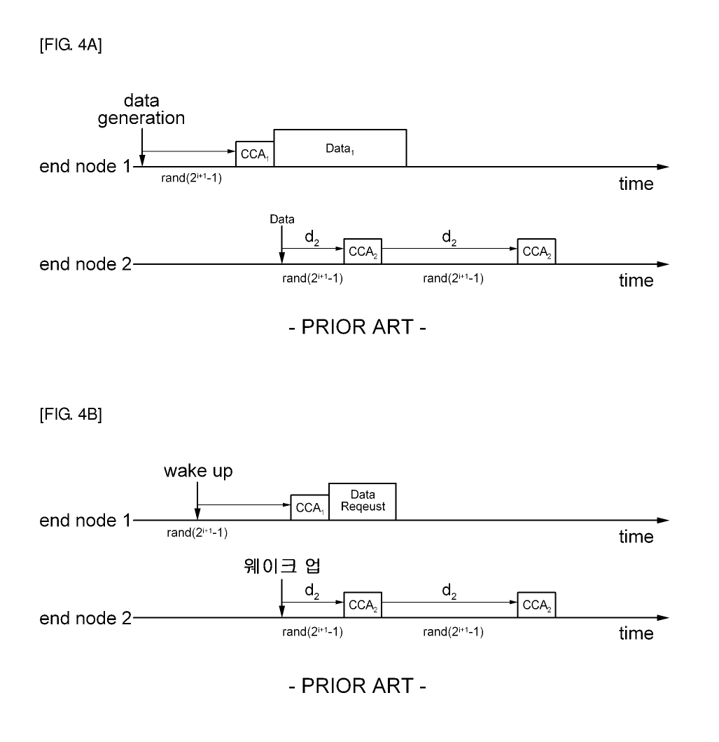

In the non-beacon method, when the end node, which has data to be received, communicates with the PAN coordinator, the end node periodically wakes up and asks whether the data is received or not. At this time, the wake-up end node can't know priority of data to be transmitted to it. Therefore, in FIGS. 4A and/or 4B of the prior art, a second end node may not be connected to the coordinator and thus delayed. That is, the second end node can be connected to the coordinator whether other nodes transmit data or not after repeatedly waiting for a random time and performing CCA operation.

The present invention intends to overcome the problem that another second end node repeatedly has to wait as in the prior art when a first end node is connected to the coordinator and a channel is busy. The non-beacon wireless network of the present invention may be, for example, a non-beacon zigbee network.

First, a data communication method in a non-beacon wireless network in accordance with a first embodiment of the present invention will be specifically described with reference to the drawings. At this time, the reference numeral that is not mentioned in the reference drawing may be the reference numeral that represents the same element in another drawing.

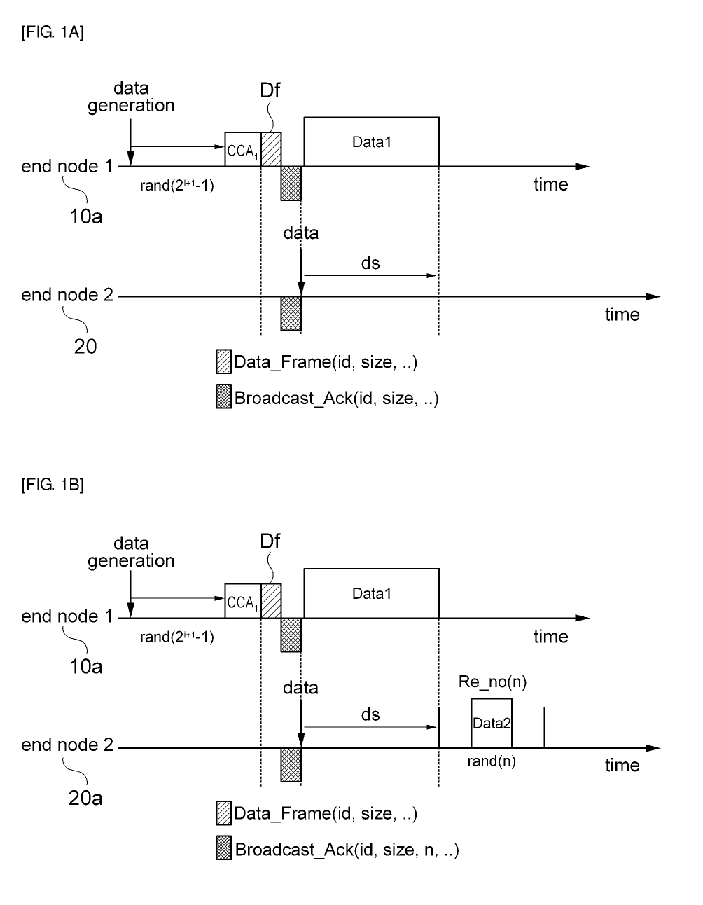

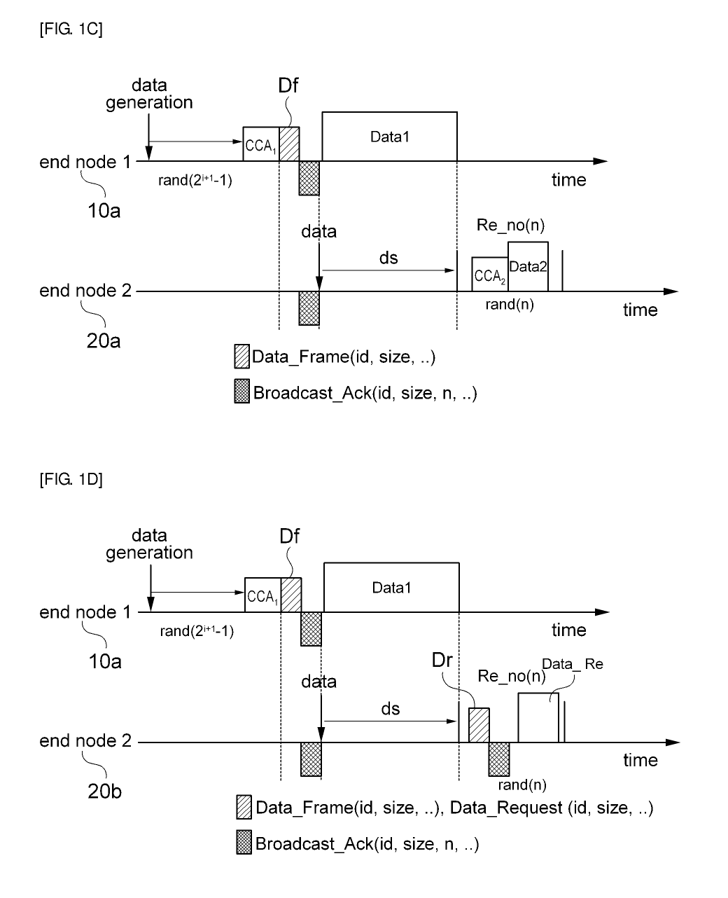

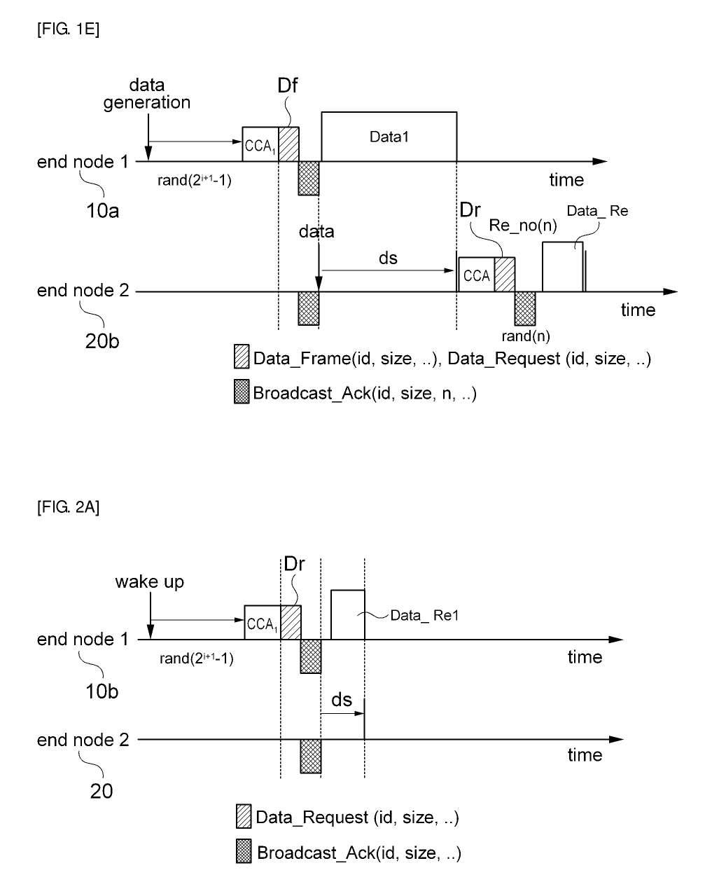

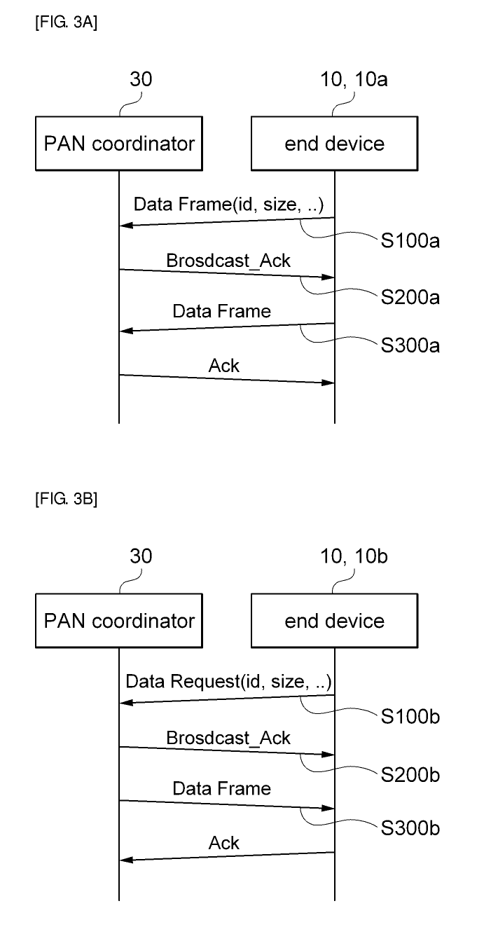

FIGS. 1A to 1E are views schematically showing a data communication method in a non-beacon wireless network in accordance with an embodiment of the present invention, and FIG. 3A is a flowchart schematically showing the data communication method in a non-beacon wireless network in accordance with an embodiment of the present invention.

Referring to FIGS. 1A to 1E and FIG. 3A, a data communication method in a non-beacon wireless network in accordance with a first embodiment includes a channel busy checking step, a first control information message transmission step (S100a), a broadcast step (S200a), and a first transmit_data transmission step (S300a). The present embodiment includes a process of transmitting first transmit_data from a first end node 10 and 10a to a coordinator 30. Since the present embodiment is applied to a non-beacon network, the first end node 10 and 10a performs a process of generating the first transmit_data and transmitting the first transmit_data in a wake-up state.

Specifically, referring to FIGS. 1A to 1E, in the channel busy checking step, the first end node 10a checks whether the coordinator (refer to 30 in FIGS. 3A and 3B) uses a channel or not. In order to transmit the first transmit_data Data 1 from the first end node 10a to the coordinator 30, the channel busy checking step is performed first. The result of checking whether the channel is busy or not is classified into idle or busy. For example, in the non-beacon environment, the first end node 10a in a wake-up state generates the first transmit_data Data 1, which is to be transmitted to the coordinator 30, and checks whether the channel is busy or not through clear channel assessment (CCA) after waiting for a random time.

At this time, in an example, the first end node 10 and 10a may determine whether the channel is busy or not by detecting a power level, a carrier or a power level and a carrier through the CCA after waiting for a random time. For example, in the CCA process, when a power threshold level is detected as higher than a predetermined level, for example, more than −82 dBm, it can be determined that the channel is currently busy. ‘rand (2ⁱ⁺¹−1)’ shown in FIGS. 1a to 1e is a random time. At this time, for example, the random time ‘rand (2ⁱ⁺¹−1)’ may be arbitrarily determined by a backoff algorithm used in the wireless sensor network. For example, ‘i’ represents the number of communication attempts, and when the state of the channel checked through the CCA after the random time by ‘3’ intervals from the first attempt is busy, the number of communication attempts may be increased to increase the random time.

Next, the first control information message transmission step (S100a) will be described with reference to FIGS. 1A to 1E and FIG. 3A. At this time, the first end node 10 and 10a transmits a first control information message Df including its ID and data size to the coordinator 30 after checking whether the channel is busy or not. As the result of checking whether the channel is busy or not, when the channel is idle, the first end node 10 and 10a transmits the first control information message Df to the coordinator 30. On the other hand, as the result of checking whether the channel is busy or not, when the channel is busy, the first end node 10 and 10a maintains a waiting state, for example, for the random time increased again. Referring to FIGS. 1A to 1E and FIG. 3A, ‘Data_Frame (id, size, . . . )’ corresponds to the first control information message Df. In the ‘Data_Frame (id, size, . . . )’, ‘id’ is an ID of the first end node 10 and 10a, and ‘size’ is a data size. Since the first control information message Df isn't actual data and has a small size, it can be transmitted within a short time.

At this time, the data size represents the size of the first transmit_data Data 1 which are to be transmitted to the coordinator 30 from the first end node 10 and 10a.

Next, the broadcast step (S200a) will be described with reference to FIGS. 1A to 1E and FIG. 3A. In the broadcast step (S200a), the coordinator 30, which receives the first control information message Df, broadcasts broadcast_ACK information including the ID and the data size included in the first control information message Df to terminals in a wake-up state. The coordinator 30, which receives the first control information message Df from the first end node 10 and 10a, returns a broadcast_ACK signal as an ACK signal. ‘Broadcast_Ack (id, size, . . . )’ shown in FIG. 1A is an example of the broadcast_ACK signal. At this time, ‘id’ represents an ID of the first end node 10 and 10a, and ‘size’ represents a data size.

Further, referring to FIGS. 1B to 1E and FIG. 3A, in an example, the broadcast_ACK information may further include rapid access interval information. ‘Broadcast_Ack (id, size, no, . . . )’ shown in FIGS. 1B to 1E and FIG. 3A is an example of the broadcast_ACK signal. At this time, ‘id’ represents an ID of the first end node 10 and 10a, ‘size’ represents a data size, and ‘no’ represents a rapid access interval value. ‘Re_no (n)’ and ‘rand (n)’ shown in FIGS. 1B and 1E represent a rapid access interval. At this time, the coordinator 30 may arbitrarily allocate the rapid access interval value ‘no’. Since the coordinator 30 provides the arbitrarily set rapid access interval ‘Re_no (n)’ through broadcasting, the terminals waiting in a wake-up state, for example, the end nodes can transmit and receive a high priority data traffic within the rapid access interval.

Next, referring to FIGS. 1A to 1E and FIG. 3A, in the first transmit_data transmission step (S300a), the first end node 10 and 10a, which receives the first broadcast_ACK information, transmits the first transmit_data Data 1 to the coordinator 30. ‘Data 1’ shown in FIGS. 1A to 1E represents the first transmit_data.

Further, an example of communication between a second end node 20 and the coordinator (refer to 30 of FIGS. 3A and 3B) will be described with reference to FIG. 1A. FIG. 1A shows the case in which only the ID and data size are included in the broadcast_ACK signal. At this time, the case in which the second end node 20 transmits data to the coordinator 30 or receives data from the coordinator 30 will be described. At this time, since it is a non-beacon environment, the second end node 20 in a sleep state requests receive_data which are to be provided to it from the coordinator 30 after wake-up. Therefore, the second end node 20, which wakes up from a sleep state, generally performs a process of requesting data which are to be received from the coordinator 30 and a process of transmitting data to the coordinator 30 when it generates or owns the transmit_data which are to be provided to the coordinator 30 from it. Hereinafter, a data transmission process will be described first, and a data reception process will be described later.

First, when the second end node 20 in a wake-up state transmits data, the process is performed in the same manner as the case in which the first end node 10a transmits data in FIG. 1A. However, as shown in FIG. 1A, when the second end node 20 receives the broadcast_ACK signal from the coordinator 30 in the first transmit_data transmission process of the first end node 10a, the initial random time may be set considering the size of the first transmit_data Data1 included in the broadcast_ACK signal.

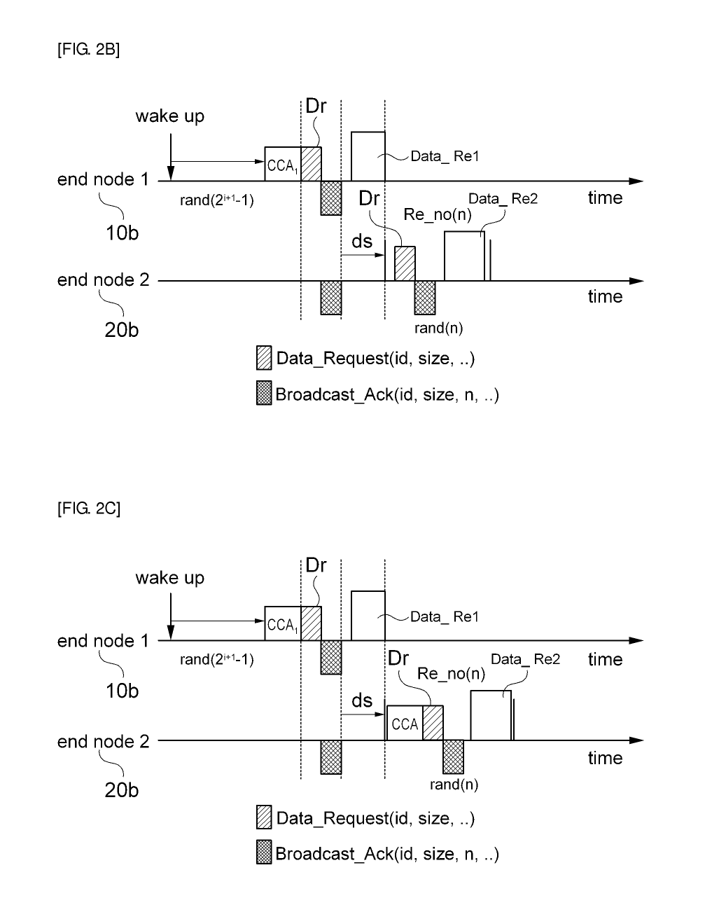

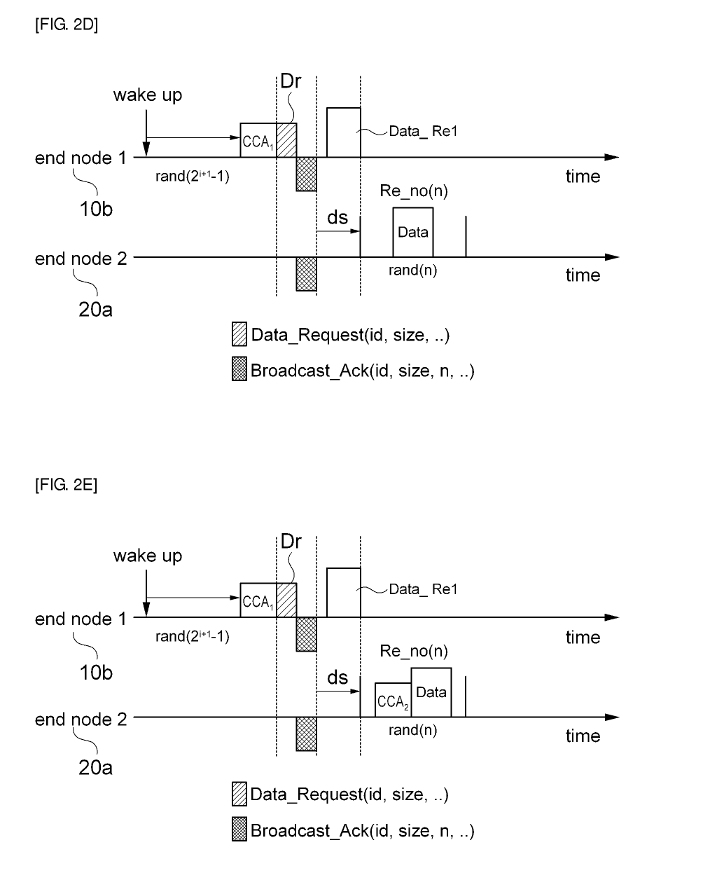

And, when the second end node 20 requests data, the process will be performed in the same manner as a first receive_data receiving process of the first end node 10b in a second embodiment described later. A specific description will refer to the receiving process of the first end node 10b in an example of FIG. 2A in accordance with the second embodiment described later.

As described above, the wake-up second end node 20 requiring data transmission and reception retries when the data transmission and reception related procedures of the first end node 10 and 10a, which currently uses the channel, finishes. Thus, it is possible to efficiently use a channel and reduce a delay time.

Further, another example will be described with reference to FIGS. 1B to 1E. FIGS. 1B to 1E show the case in which the rapid access interval information is further included in the broadcast_ACK signal. At this time, the case in which the second end node 20a and 20b transmits data to the coordinator 30 or receives data from the coordinator 30 will be described. Even in this case, as in FIG. 1A, the second end node 20b preferentially performs a process of receiving data, which is to be provided to it, from the coordinator 30 after waking up from a sleep state. When there are transmit_data provided to the coordinator 30, the second end node 20a performs a process of transmitting data to the coordinator 30.

First, referring to FIGS. 1D and 1E, in an example, the data communication method in a non-beacon wireless network may further include a second control information message transmission step of the second end node 20b. In general, the wake-up second end node 20b performs a process of requesting receive_data, which are to be provided to it from the coordinator 30, first. At this time, referring to FIG. 1d, the wake-up second end node 20b receives the broadcast_ACK information from the coordinator 30 in the first transmit_data transmission process of the first end node 10a. At this time, the second end node 20b may transmit a second control information message Dr including its ID and data size to the coordinator 30 within the rapid access interval included in the broadcast_ACK information after waiting as long as the size of the first transmit_data Data 1 included in the broadcast_ACK information. At this time, the data size included in the second control information message Dr is “0” (zero). In FIGS. 1D and 1E, the second control information message Dr is shown as ‘Data_Request (id, size, . . . )’. At this time, the second control information message ‘Data_Request (id, size, . . . )’ is the same format as the first control information message ‘Data_Frame (id, size, . . . )’. However, there is a difference in that the data size ‘size’ is “0” (zero). Thus, the coordinator 30 can determine whether the second end node 20b requests receive_data from it or transmits transmit_data to it from whether the data size included in the received second control information message Dr is “0” (zero).

In FIGS. 1D and 1E, since the second end node 20b requests receive_data ‘Data_Re’, if the coordinator 30 has the receive_data ‘Data_Re’, the coordinator 30 broadcasts a second broadcast_ACK signal including the size of the receive_data provided to the second end node 20b as shown in FIGS. 1D and 1E.

And, as shown in FIGS. 1D and 1E, after broadcasting, the coordinator 30 may transmit the receive_data ‘Data_Re’ to the second end node 20b. At this time, the size of the receive_data may deviate from the rapid access interval. That is, it is enough if only the second control information message Dr can be received from the second end node 20b within the rapid access interval.

Further, at this time, referring to FIG. 1E, the second end node 20b may transmit the second control information message Dr after checking whether the channel is busy or not within the rapid access interval. Checking whether the channel is busy or not may be performed similarly to the channel busy checking step of the first end node 10a.

Next, referring to FIGS. 1B and 1C, in an example, the data transmission method in a non-beacon wireless network may further include a second transmit_data transmission step of the second end node 20b. Referring to FIG. 1B, when the wake-up second end node 20a, which wants to transmit data, receives the broadcast_ACK information, the second end node 20a may start to transmit second transmit_data Data 2 to the coordinator 30 within the rapid access interval after waiting as long as the size of the first transmit_data Data 1 included in the broadcast_ACK information. At this time, when the transmission of the second transmit_data Data 2 within the rapid access interval starts, there is no problem even though the size of the second transmit_data deviates from the rapid access interval.

Further, referring to FIG. 1C in accordance with an example, in the second transmit_data transmission step of the second end node 20a, the second end node 20a may start to transmit the second transmit_data Data 2 after checking whether the channel is busy or not within the rapid access interval.

Next, a data communication method in a non-beacon wireless network in accordance with a second embodiment of the present invention will be specifically described with reference to the following drawings. At this time, the data communication method in a non-beacon wireless network in accordance with the above-described first embodiment will be referenced. Accordingly, repeated descriptions may be omitted.

FIGS. 2A to 2E are views schematically showing a data communication method in a non-beacon wireless network in accordance with another embodiment of the present invention, and FIG. 3B is a flowchart schematically showing the data communication method in a non-beacon wireless network in accordance with another embodiment of the present invention.

Referring to FIGS. 2A to 2E and FIG. 3B, a data communication method in a non-beacon wireless network in accordance with a second embodiment includes a channel busy checking step, a first control information message transmission step (S100b), a broadcast step (S200b), and a first receive_data reception step (S300b). The present embodiment includes a process of receiving first receive_data in a first end node 10 and 10b from a coordinator 30.

Specifically, referring to FIGS. 2A to 2E, in the channel busy checking step, the first end node 10b checks whether the coordinator 30 uses a channel or not.

At this time, in an example, in the channel busy checking step, the first end node 10b can determine whether the channel is busy or not by detecting a power level, a carrier or a power level and a carrier through clear channel assessment (CCA) after waiting for a random time.

Next, the first control information message transmission step (S100b) will be described with reference to FIGS. 2A to 2E and FIG. 3B. At this time, the first end node 10 and 10b transmits a first control information message Dr including its ID and data size to the coordinator 30 after checking whether the channel is busy or not.

At this time, the data size included in the first control information message Dr is “0” (zero). ‘Data_Request (id, size, . . . )’ shown in FIGS. 2A to 2E and FIG. 3B is the first control information message Dr. This first control information message Df is the same format as the first control information message Df, that is, ‘Data_Frame (id, size, . . . )’ in the above-described first embodiment. However, there is a difference in that the data size ‘size’ is “0” (zero). At this time, when the data size included in the first control information message Dr is “0” (zero), the coordinator 30, which received the first control information message Dr, can grasp whether the first end node 10b corresponding to ID requests receive_data Data_Re from it or not. When the coordinator 30 has the receive_data requested by the first end node 10b, broadcast_ACK information is broadcasted in the next process.

Continuously, the broadcast step (S200b) will be described with reference to FIGS. 2A to 2E and FIG. 3B. In the broadcast step (S200b), the coordinator 30, which received the first control information message Dr, broadcasts the broadcast_ACK information including the ID included in the first control information message Dr and the size of first receive_data (Data_Re1) requested by the first end node 10b to terminals in a wake-up state. ‘Broadcast_Ack (id, size, . . . )’ shown in FIG. 2a is an example of a broadcast_ACK signal.

For example, referring to FIGS. 2B to 2E and FIG. 3B, in an example, the broadcast_ACK information may further include rapid access interval information. ‘Broadcast_Ack (id, size, no, . . . )’ shown in FIGS. 2B to 2E and 3B is an example of the broadcast_ACK signal. In FIGS. 2B to 2E and FIG. 3B, ‘id’ represents an ID of the first end node 10b, ‘size’ represents a data size, and ‘no’ represents a rapid access interval value. ‘Re_no (n)’ and ‘rand (n)’ shown in FIGS. 2B to 2E represent a rapid access interval. At this time, the coordinator 30 may arbitrarily allocate the rapid access interval value ‘no’. Since the coordinator 30 provides the arbitrarily set rapid access interval ‘Re_no (n)’ through broadcasting, the terminal waiting in a wake-up state, for example, the end nodes can transmit and receive a high priority data traffic within the rapid access interval.

Continuously, the first receive_data reception step (S300b) will be described with reference to FIGS. 2A to 2E and FIG. 3B. At this time, after broadcasting, the first end node 10b receives first receive_data transmitted from the coordinator 30. ‘Data_Re1’ shown in FIGS. 2A to 2E represents the first receive_data.

Further, an example of communication between a second end node 20 and the coordinator 30 will be described with reference to FIG. 2A. FIG. 2A shows the case in which only the ID and data size are included in the broadcast_ACK signal. In general, the wake-up second end node 20 performs a process of requesting receive_data, which are to be provided to it from the coordinator 30, first. After that, when the second end node 20 generates transmit_data, which are to be transmitted to the coordinator 30 from it, the second end node 20 transmits the transmit_data to the coordinator 30.

First, when the wake-up second end node 20 requests data, the process is performed in the same manner as the case in which the first end node 10b receives data in FIG. 2A. However, as shown in FIG. 2A, when the second end node 20 receives the broadcast_ACK signal from the coordinator 30 in the first receive_data reception process of the first end node 10b, the initial random time may be set considering the size of the first receive_data Data_Re1 included in the broadcast_ACK signal.

And, when the second end node 20 wants to transmit data, the process is performed in the same manner as the first transmit_data transmission process of the first end node 10a in the above-described first embodiment according to an example of FIG. 2A. Thus, repeated descriptions will be omitted.

Further, another example will be described with reference to FIGS. 2B to 2E. FIGS. 2B to 2E show the case in which rapid access interval information is further included in the broadcast_ACK signal. At this time, the case in which the second end node 20a and 20b transmits data to the coordinator 30 or receives data from the coordinator 30 will be described. In general, the wake-up second end node 20b performs a process of requesting receive_data by checking whether the coordinator 30 has data to be provided to it first.

At this time, referring to FIGS. 2B and 2C, in an example, the data communication method in a non-beacon wireless network may further include a second control information message transmission step. The wake-up second end node 20b in a non-beacon environment performs a process of requesting receive_data, which are to be provided to it from the coordinator 30, first. Specifically describing with reference to FIGS. 2B and 2C, when the wake-up second end node 20b receives the broadcast_ACK information, the second end node 20b may transmit a second control information message Dr including its ID and data size to the coordinator 30 within the rapid access interval included in the broadcast_ACK information after waiting as long as the size of the first receive_data included in the broadcast_ACK information. At this time, the data size included in the second control information message Dr is “0” (zero).

Further, in FIGS. 2D and 2E, since the second end node 20b requests second receive_data ‘Data_Re2’ to be received, if the coordinator 30 has the second receive_data ‘Data_Re2’, a second broadcast_ACK signal including the size of the second receive_data Data_Re2 which are to be provided to the second end node 20b is broadcasted. If the coordinator 30 doesn't have data to be provided to the second end node 20b, that is, there is no data to be provided to the second end node 20b, the coordinator 30 may return ‘no data’ as an ACK signal.

And, as shown in FIGS. 2D and 2E, after broadcasting, the coordinator 30 may transmit the second receive_data ‘Data_Re2’ to the second end node 20b. At this time, the size of the second receive_data may deviate from the rapid access interval. That is, it is enough if only the second control information message Dr can be received from the second end node 20b within the rapid access interval.

Further, referring to FIG. 2C, in the second control information message transmission step, the second end node 20b may transmit the second control information message Dr after checking whether the coordinator 30 uses the channel or not within the rapid access interval.

Further, referring to FIGS. 2D and 2E, in an example, the data transmission method in a non-beacon wireless network may further include a transmit_data transmission step. The wake-up second end node 20a, which wants to transmit data, receives the broadcast_ACK information, the second end node 20a may start to transmit transmit_data Data to the coordinator 30 within the rapid access interval after waiting as long as the size of the first receive_data included in the broadcast_ACK information. At this time, when the transmission of the transmit_data Data within the rapid access interval starts, there is no problem even though the size of the transmit_data deviates from the rapid access interval.

At this time, referring to FIG. 2E, in the transmit_data transmission step, the second end node 20a may start to transmit the transmit_data after checking whether the coordinator 30 uses the channel or not within the rapid access interval.

Next, a non-beacon wireless network communication system in accordance with a third embodiment of the present invention will be specifically described with reference to the drawings. At this time, the data communication method in a non-beacon wireless network in accordance with the above-described first and second embodiments will be referenced. Thus, repeated descriptions may be omitted.

FIGS. 1A to 1E are views schematically showing a portion of a non-beacon wireless network communication system in accordance with an embodiment of the present invention, and FIGS. 2A to 2E are views schematically showing another portion of the non-beacon wireless network communication system in accordance with an embodiment of the present invention. FIGS. 3A and 3B are views schematically showing a flow of signals in the non-beacon wireless network communication system in accordance with an embodiment of the present invention.

Referring to FIGS. 1A to 1E, FIGS. 2A to 2E, and FIGS. 3A and 3B, a non-beacon wireless network communication system in accordance with a third embodiment includes a first end node 10, 10a, and 10b and a coordinator 30. Further, referring to FIGS. 1A to 1E and FIGS. 2A to 2E, in an example, the non-beacon wireless network communication system in accordance with the third embodiment may further include a second end node 20, 20a, and 20b.

The first end node 10, 10a, and 10b will be described with reference to FIGS. 1A to 1E, FIGS. 2A to 2E, and FIGS. 3A and 3B. Referring to FIGS. 1A to 1E and FIGS. 2B to 2E, the first end node 10a, and 10b checks whether the coordinator 30 uses a channel or not. At this time, in an example, the first end node 10a and 10b may determine whether the channel is busy or not by detecting a power level, a carrier or a power level and a carrier through clear channel assessment (CCA) after waiting for a random time.

Further, referring to FIGS. 1A to 1E, FIGS. 2A to 2E, and FIGS. 3A and 3B, the first end node 10, 10a, and 10b transmits a first control information message Df and Dr including its ID and a first data size to the coordinator 30 after checking whether the channel is busy or not. At this time, when the first end node 10 and 10a transmits first transmit_data Data 1, the first data size included in the first control information message Df is the size of the first transmit_data Data 1. When the first end node 10 and 10b requests first receive_data Data_Re1, the first data size included in the first control information message Dr is “0” (zero). At this time, the first receive_data Data_Re1 are data which should be provided to the first end node 10b by the coordinator 30. Accordingly, the coordinator 30, which received the first control information message Df and Dr, grasps that the first end node 10 and 10b requests the first receive_data Data_Re1 when the first data size is “0” (zero), and the coordinator 30 grasps that the first end node 10 and 10a transmits the first transmit_data Data 1 when the first data size is not “0” (zero).

Continuously, referring to FIGS. 1A to 1E, FIGS. 2A to 2E, and FIGS. 3A and 3B, the first end node 10, 10a, and 10b receives broadcast_ACK information of the coordinator 30 for the first control information message Df and Dr.

Further, referring to FIGS. 1A to 1E, FIGS. 2A to 2E, and FIGS. 3A and 3B, after receiving the broadcast_ACK information, the first end node 10 and 10a transmits the first transmit_data Data 1 to the coordinator 30 or receives the first receive_data from the coordinator 30.

Next, the coordinator 30 will be described with reference to FIGS. 1A to 1E, FIGS. 2A to 2E, and FIGS. 3A and 3B. The coordinator 30 receives the first control information message Df and Dr from the first end node 10, 10a, and 10b. Further, the coordinator 30 broadcasts the broadcast_ACK information including the ID of the first end node 10, 10a, and 10b and a second data size obtained from the first control information message Df and Dr. At this time, when the first end node 10 and 10a transmits the first transmit_data Data 1, the second data size is the size of the first transmit_data Data 1. When the first end node 10 and 10b requests the first receive_data Data_Re1, the second data size is the size of the first receive_data. At this time, if the coordinator 30 doesn't have data to be provided to the first end node 10b, only an ACK signal, which confirms that there is no data, is transmitted to the first end node 10b.

Further, referring to FIGS. 1B to 1E, FIGS. 2B to 2E, and FIGS. 3A and 3B in accordance with an example, the broadcast_ACK information may further include rapid access interval information.

When the first end node 10, 10a, and 10b proceeds data transmission and reception procedures with the PAN coordinator 30, since the coordinator 30 broadcasts the information including the size of the data which are to be transmitted and received, other end nodes in a wake-up state can obtain the right to use a channel by waiting as long as the broadcasted data size without recklessly repeatedly waiting. Further, in an example, since the coordinator 30 allocates a rapid access interval and broadcasts the broadcast information by including the allocated rapid access interval in the broadcast information, other end nodes can receive a high priority receive traffic without delay by obtaining the right to use a channel in the rapid access interval.

Further, after broadcasting, the coordinator 30 receives the first transmit_data Data 1 from the first end node 10 and 10a or transmits the first receive_data Data_Re1 to the first end node 10 and 10b.

Further, referring to FIGS. 1A to 1E and FIGS. 2A to 2E, in an example, the non-beacon wireless network communication system may further include a second end node 20, 20a, and 20b. The case of FIGS. 1A and 2A, the case of FIGS. 1B to 1E, and the case of FIGS. 2B to 2E will be separately described.

At this time, since the wake-up second end node 20, 20a, and 20b, which requires data transmission and reception can retry when the data transmission and reception related procedures of the first end node 10 and 10a, which currently uses the channel, finishes. Thus, it is possible to efficiently use a channel and reduce a delay time.

First, in the case of FIGS. 1A and 2A, the rapid access interval information is excluded from the broadcast_ACK signal which is broadcasted by the coordinator 30. At this time, the second end node 20 has the same function as the first end node 10a and 10b in the case of FIGS. 1A to 1E and FIGS. 2A to 2E. Other specific descriptions will reference the above-described first and second embodiments.

Meanwhile, in the case of FIGS. 1B to 1E and FIGS. 2B to 2E, the broadcast_ACK information which is broadcasted by the coordinator 30 further includes the rapid access interval information. At this time, referring to FIGS. 1B to 1E and FIGS. 2B to 2E, the second end node 20a and 20b receives the broadcast_ACK information in a wake-up state.

At this time, the second end node 20b, which received the broadcast_ACK information, transmits a second control information message Dr including its ID and a third data size within the rapid access interval to the coordinator 30 after waiting as long as the second data size included in the broadcast_ACK information when requesting second receive_data Data_Re2 from the coordinator 30. The second receive_data Data_Re2 are data which are provided to the second end node 20b from the coordinator 30. At this time, since the second end node 20b requests the second receive_data, the third data size included in the second control information message Dr is “0” (zero).

And, when the second end node 20a, which received the broadcast_ACK information, wants to transmit second transmit_data to the coordinator 30, the second end node 20a starts to transmit the second transmit_data to the coordinator 30 within the interval access interval after waiting as long as the second data size included in the broadcast_ACK information.

Further, referring to FIGS. 1C and 1E in accordance with an example, the second end node 20b transmits the second control information message Dr after checking whether the coordinator 30 uses a channel or not within the rapid access interval when requesting the second receive_data. Further, the second end node 20a starts to transmit the second transmit_data after checking whether the coordinator 30 uses a channel or not within the rapid access interval when it wants to transmit the second transmit_data.

According to the embodiment of the present invention, it is possible to reduce a receive delay time of an end node only by a PAN coordinator and a simple information message. Further, it is possible to efficiently use a channel and reduce a delay time by broadcasting information including the size of transmitted and received data, which use the channel, to terminals in a wake-up state through a coordinator.

Further, according to the embodiments of the present invention, when the first end node proceeds data transmission and reception procedures with the coordinator, by broadcasting information including the size of transmitted and received data through the coordinator, other end nodes in a wake-up state can obtain the right to use a channel by waiting as long as the data size without recklessly repeatedly waiting. Accordingly, it is possible to efficiently use a channel and reduce a delay time.

Further, according to an embodiment, since the coordinator allocates a rapid access interval and transmits the broadcast information by including the allocated rapid access interval in the broadcast information, other end nodes can obtain the right to use a channel in the rapid access interval to receive a high priority receive traffic without delay.

Further, according to the embodiment of the present invention, it is not needed to greatly change the conventional algorithm and perform operations such as addition of additional functions since the process defined in the conventional Zigbee standards is not greatly changed.

Further, in an example, it is possible to receive data within a short delay time by receiving data in the rapid access interval when it is needed to receive high priority data.

In addition, it is easy to be applied due to simple operations.

It is apparent that various effects which have not been directly mentioned according to the various embodiments of the present invention can be derived by those skilled in the art from various constructions according to the embodiments of the present invention.

The above-described embodiments and the accompanying drawings are provided as examples to help understanding of those skilled in the art, not limiting the scope of the present invention. Further, embodiments according to various combinations of the above-described components will be apparently implemented from the foregoing specific descriptions by those skilled in the art. Therefore, the various embodiments of the present invention may be embodied in different forms in a range without departing from the essential concept of the present invention, and the scope of the present invention should be interpreted from the invention defined in the claims. It is to be understood that the present invention includes various modifications, substitutions, and equivalents by those skilled in the art.

What is claimed is:

1. A data communication method in a non-beacon wireless network, comprising:
checking whether a coordinator uses a channel or not by a first end node;
transmitting a first control information message including its ID and data size to the coordinator after checking whether the channel is busy or not by the first end node;
broadcasting broadcast_ACK information including the ID and the data size by the coordinator receiving the first control information message; and
transmitting first transmit_data to the coordinator by the first end node receiving the broadcast_ACK information, wherein the data size is the size of the first transmit_data.

2. The data communication method in a non-beacon wireless network according to claim 1, wherein in checking whether the channel is busy or not, the first end node determines whether the channel is busy or not by detecting a power level, a carrier or a power level and a carrier through clear channel assessment (CCA) after waiting for a random time.

3. The data communication method in a non-beacon wireless network according to claim 1, wherein the broadcast_ACK information further comprises rapid access interval information.

4. The data communication method in a non-beacon wireless network according to claim 3, further comprising:
transmitting a second control information message including its ID and data size to the coordinator within the rapid access interval after waiting as long as the size of the first transmit_data included in the broadcast_ACK information when a wake-up second end node receives the broadcast_ACK information, wherein the data size included in the second control information message is 0 (zero).

5. The data communication method in a non-beacon wireless network according to claim 4, wherein in transmitting the second control information message, the second end node transmits the second control information message after checking whether the channel is busy or not within the rapid access interval.

6. The data communication method in a non-beacon wireless network according to claim 3, further comprising:
starting transmission of second transmit_data to the coordinator within the rapid access interval after waiting as long as the size of the first transmit_data included in the broadcast_ACK information when the wake-up second end node, which wants to transmit data, receives the broadcast_ACK information.

7. The data communication method in a non-beacon wireless network according to claim 6, wherein in transmitting the second transmit_data, the second end node starts the transmission of the second transmit_data after checking whether the channel is busy or not within the rapid access interval.

8. A data communication method in a non-beacon wireless network, comprising:
checking whether a coordinator uses a channel or not by a first end node;
transmitting a first control information message including its ID and data size to the coordinator after checking whether the channel is busy or not by the first end node;
broadcasting broadcast_ACK information including the ID and the size of first receive_data, which are requested by the first end node, by the coordinator receiving the first control information message; and
receiving the first receive_data, which are transmitted by the coordinator, after broadcasting by the first end node, wherein the data size included in the first control information message is 0 (zero).

9. The data communication method in a non-beacon wireless network according to claim 8, wherein in checking whether the channel is busy or not, the first end node determines whether the channel is busy or not by detecting a power level, a carrier or a power level and a carrier through clear channel assessment (CCA) after waiting for a random time.

10. The data communication method in a non-beacon wireless network according to claim 8, wherein the broadcast_ACK information further comprises rapid access interval information.

11. The data communication method in a non-beacon wireless network according to claim 10, further comprising:
transmitting a second control information message including its ID and data size to the coordinator within the rapid access interval after waiting as long as the size of the first receive_data included in the broadcast_ACK information when a wake-up second end node receives the broadcast_ACK information, wherein the data size included in the second control information message is 0 (zero).

12. The data communication method in a non-beacon wireless network according to claim 11, wherein in transmitting the second control information message, the second end node transmits the second control information message after checking whether the channel is busy or not within the rapid access interval.

13. The data communication method in a non-beacon wireless network according to claim 10, further comprising:
starting transmission of transmit_data to the coordinator within the rapid access interval after waiting as long as the size of the first receive_data included in the broadcast_ACK information when the wake-up second end node, which wants to transmit data, receives the broadcast_ACK information.

14. The data communication method in a non-beacon wireless network according to claim 13, wherein in transmitting the transmit_data, the second end node starts the transmission of the transmit_data after checking whether the channel is busy or not within the rapid access interval.

15. A non-beacon wireless network communication system comprising:
a first end node for checking whether a coordinator uses a channel or not, transmitting a first control information message including its ID and a first data size to the coordinator after checking whether the channel is busy or not, receiving broadcast_ACK information of the coordinator for the first control information message, and transmitting first transmit_data to the coordinator or receive first receive_data from the coordinator after receiving the broadcast_ACK information; and
the coordinator for receiving the first control information message from the first end node, broadcasting the broadcast_ACK information including the ID and a second data size, and receiving the first transmit_data from the first end node or transmitting the first receive_data to the first end node, wherein when the first end node transmits the first transmit_data, the first data size and the second data size are the size of the first transmit_data, and when the first end node requests the first receive_data, the first data size is 0 (zero) and the second data size is the size of the first receive_data.

16. The non-beacon wireless network communication system according to claim 14, wherein the first end node determines whether the channel is busy or not by detecting a power level, a carrier or a power level and a carrier through CCA after waiting for a random time.

17. The non-beacon wireless network communication system according to claim 14, wherein the broadcast_ACK information further comprises rapid access interval information.

18. The non-beacon wireless network communication system according to claim 17, further comprising:
a second end node for receiving the broadcast_ACK information in a wake-up state, transmitting a second control information message including its ID and a third data size to the coordinator within the rapid access interval after waiting as long as the second data size included in the broadcast_ACK information when requesting second receive_data from the coordinator, and starting transmission of second transmit_data to the coordinator within the rapid access interval after waiting as long as the second data size included in the broadcast ACK_information when transmitting the second transmit_data to the coordinator, wherein the third data size included in the second control information message is 0 (zero).

19. The non-beacon wireless network communication system according to claim 18, wherein the second end node transmits the second control information message after checking whether the coordinator uses the channel or not within the rapid access interval when requesting the second receive_data, and starts the transmission of the second transmit_data after checking whether the channel is busy or not within the rapid access interval when transmitting the second transmit_data.
